(19) United States
(12) Patent Application Publication
(10) Pub. No.: US 2020/0042660 A1
(43) Pub. Date: Feb. 6, 2020

(54) Parallel Computation Efficiency Improvements In Particle-Based Numerical Simulation Of Explosion Event

(71) Applicant: Livermore Software Technology Corporation, Livermore, CA (US)

(72) Inventor: Hailong Teng, Livermore, CA (US)

(21) Appl. No.: 16/051,782

(22) Filed: Aug. 1, 2018

(51) Int. Cl. G06F 17/50

(52) U.S. Cl. CPC G06F 17/5018; G06F 2217/16; G06F 17/5095

(57) ABSTRACT

A particle-based method model containing a number of particles for representing a domain of an explosion event in a time-marching simulation is received in multi-processor computer system. The domain is divided into a set of sub-domains with each sub-domain containing substantially equal number of particles. Sub-domains are assigned to respective processors of the computer system. Numerically-calculated particle behaviors are obtained by conducting time-marching simulation in parallel computations according to the particle-based method. When the simulation time has not reached a predefined termination time, total number of particles in each sub-domain is summed up after each solution cycle. If an indicator derived from the total number of particles in each sub-domain shows workload imbalance, the domain is repartitioned with number of particles rebalanced into new set of sub-domains before conducting further time-marching simulation. Otherwise the time-marching simulation is conducted with the existed set of sub-domains.

### FIELD

This patent document generally relates to computer related technology—computer aided mechanical engineering analysis. More particularly the present document relates to parallel computation efficiency improvements in particle-based numerical simulations of explosion event.

### BACKGROUND

Particle-based methods have been used for numerically simulating many physical phenomena. There are a number of particle-based methods including, but not limited to, Corpuscular Particle Methodology (CPM), discrete element method (DEM), Smoothed-Particle Hydrodynamics (SPH), meshfree method. For airbag deployment, one particle-based method based on CPM has been used.

CPM includes the effects of transient gas dynamics and thermodynamics by using a particle to represent a set of air or gas molecules and then a set of particles to represent the entire air or gas molecule in the space of interest.

In order to properly simulate physical behaviors of certain product (e.g., airbag), other computational methods need to be used in conjunction with CPM. For example, finite element analysis (FEA) or finite element method (FEM). Two-dimensional finite elements (i.e., shell elements) are used for representing the airbag fabric while the exploding air is represented with particles based on CPM method.

FEA is a computerized method widely used in industry to model and solve engineering problems relating to complex systems such as three-dimensional non-linear structural design and analysis. FEA derives its name from the manner in which the geometry of the object under consideration is specified. With the advent of the modern digital computer, FEA has been implemented as FEA software. Basically, the FEA software is provided with a grid-based model of the geometric description and the associated material properties at each point within the model. In this model, the geometry of the system under analysis is represented by solids, shells and beams of various sizes, which are called elements. The vertices of the elements are referred to as nodes. The model is comprised of a finite number of elements, which are assigned a material name to associate with material properties. The model thus represents the physical space occupied by the object under analysis along with its immediate surroundings. The FEA software then refers to a table in which the properties (e.g., stress-strain constitutive equation, Young's modulus, Poisson's ratio, thermo-conductivity) of each material type are tabulated. Additionally, the conditions at the boundary of the object (i.e., loadings, physical constraints, etc.) are specified. In this fashion a model of the object and its environment is created.

Once the model is defined, FEA software can be used for performing a numerical simulation of the physical behavior under the specified loading or initial conditions. FEA software is used extensively in the automotive industry to simulate front and side impacts of automobiles, occupant dummies interacting with airbags, and the forming of body parts from sheet metal. Such simulations provide valuable insight to engineers who are able to improve the safety of automobiles and to bring new models to the market more quickly. The simulation is performed in time domain meaning the FEA is computed at many solution cycles starting from an initial solution cycle, at each subsequent solution cycle, the simulation time is incremented by a time step referred to as ΔT. Such simulation is referred to as time-marching simulation.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

A particle-based method model containing a number of particles for representing a domain of an explosion event in a time-marching simulation is received in multi-processor computer system. The domain is divided into a set of sub-domains with each sub-domain containing substantially equal number of particles. Sub-domains are assigned to respective processors of the computer system. Numerically-calculated particle behaviors are obtained by conducting time-marching simulation in parallel computations according to the particle-based method. When the simulation time has not reached a predefined termination time, total number of particles in each sub-domain is summed up after each solution cycle. If an indicator derived from the total number of particles in each sub-domain shows workload imbalance, the domain is repartitioned with number of particles rebalanced into new set of sub-domains before conducting further time-marching simulation. Otherwise the time-marching simulation is conducted with the existed set of sub-domains.

With advent of computer technology, parallel computing has been used in many applications including, but not limited to, FEA, CPM, DEM, SPH, etc. Parallel computing is a type of computation in which many calculations or the execution of processes are carried out concurrently. One dominant paradigm in computer architecture is in the form of multi-core processors. Or a computer system formed with multiple processors with each processor containing multiple cores.

Theoretically, the computations of a given numerical simulation would be completed faster. However, there are challenges associated with parallel computing. In parallel computing, a computational task is typically broken down into several, often many, very similar subtasks that can be processed independently and whose results are combined afterwards, upon completion. In contrast, in concurrent computing, the various processes often do not address related tasks; when they do, as is typical in distributed computing, the separate tasks may have a varied nature and often require some inter-process communication during execution. Then the results of separate tasks are sent to relevant respective processors for further computations. Communication and synchronization between the different subtasks are typically some of the greatest obstacles to getting good parallel program performance.

Other objects, features, and advantages will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIG. 1 is a function diagram showing salient components of a computing system, in which an embodiment of the invention may be implemented;

FIG. 2 is a flowchart illustrating an example process of improving parallel computation efficiency of a numerical simulation of an explosion event based on particle-based method, according to an embodiment of the invention;

FIG. 3 is a diagram illustrating an example recursively coordinate bisection decomposition scheme, according to an embodiment of the invention;

FIGS. 4A-4C are a sequence of diagrams showing example sub-domains used in particle-based method according to one embodiment of the invention;

FIGS. 5A-5B are diagrams showing example distribution of particles in a multi-processor computer system, according to an embodiment of the invention;

FIGS. 6A-6C are diagrams illustrating an example sequence of an airbag deployment using particle-based method, according to an embodiment of the invention;

FIG. 7 is a diagram showing example particle-based method used in a numerical simulation of inflating an airbag according to an embodiment of the invention.

### DETAILED DESCRIPTION

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

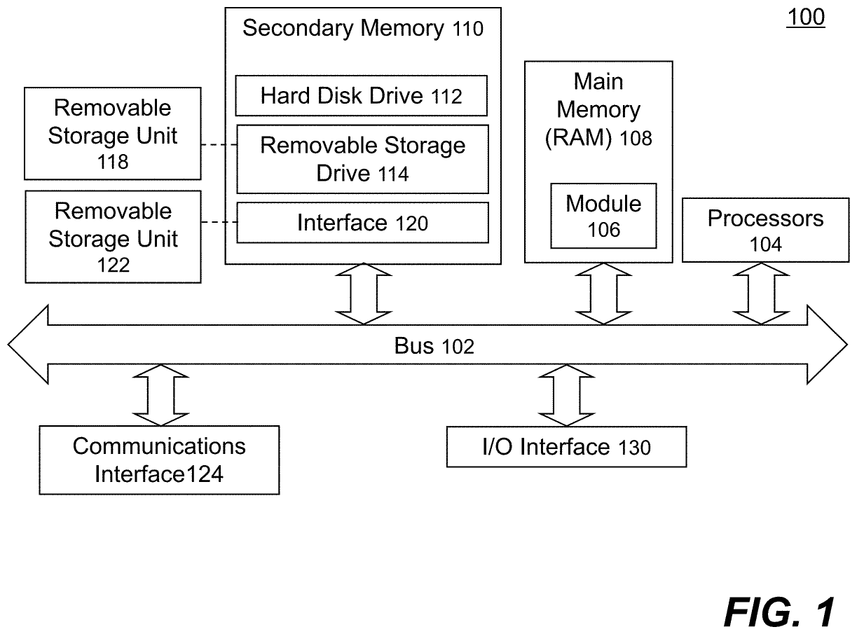

Embodiments of the invention are discussed herein with reference to FIGS. 1-7. However, those skilled in the art will readily appreciate that the detailed description given herein with respect to these figures is for explanatory purposes as the invention extends beyond these limited embodiments.

According to one aspect, the invention is directed towards one or more special-purpose programmed computer systems capable of carrying out the functionality described herein. An example of a computer system 100 is shown in FIG. 1. The computer system 100 contains multiple processors, such as processors 104. The processors 104 are connected to a computer system internal communication bus 102. Various software embodiments are described in terms of this exemplary computer system. After reading this description, it will become apparent to a person skilled in the relevant art(s) how to implement the invention using other computer systems and/or computer architectures.

Computer system 100 also includes a main memory 108, preferably random access memory (RAM), and may also include a secondary memory 110. The secondary memory 110 may include, for example, one or more hard disk drives 112 and/or one or more removable storage drives 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, flash memory stick, etc. which is read by and written to by removable storage drive 114. As will be appreciated, the removable storage unit 118 includes a computer readable storage medium having stored therein computer software and/or data.

In alternative embodiments, secondary memory 110 may include other similar means for allowing computer programs or other instructions to be loaded into computer system 100. Such means may include, for example, a removable storage unit 122 and an interface 120. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 122 and interfaces 120 which allow software and data to be transferred from the removable storage unit 122 to computer system 100. In general, Computer system 100 is controlled and coordinated by operating system (OS) software, which performs tasks such as process scheduling, memory management, networking and I/O services.

There may also be a communications interface 124 connecting to the bus 102. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124. The computer 100 communicates with other computing devices over a data network based on a special set of rules (i.e., a protocol). One of the common protocols is TCP/IP (Transmission Control Protocol/Internet Protocol) commonly used in the Internet. In general, the communication interface 124 manages the assembling of a data file into smaller packets that are transmitted over the data network or reassembles received packets into the original data file. In addition, the communication interface 124 handles the address part of each packet so that it gets to the right destination or intercepts packets destined for the computer 100. In this document, the terms “computer program medium”, “computer readable medium”, “computer recordable medium” and “computer usable medium” are used to generally refer to media such as removable storage drive 114 (e.g., flash storage drive), and/or a hard disk installed in hard disk drive 112. These computer program products are means for providing software to computer system 100. The invention is directed to such computer program products.

The computer system 100 may also include an input/output (I/O) interface 130, which provides the computer system 100 to access monitor, keyboard, mouse, printer, scanner, plotter, and the likes.

Computer programs (also called computer control logic) are stored as application modules 106 in main memory 108 and/or secondary memory 110. Computer programs may also be received via communications interface 124. Such computer programs, when executed, enable the computer system 100 to perform the features of the invention as discussed herein. In particular, the computer programs, when executed, enable the processors 104 to perform features of the invention. Accordingly, such computer programs represent controllers of the computer system 100.

In an embodiment where the invention is implemented using software, the software may be stored in a computer program product and loaded into computer system 100 using removable storage drive 114, hard drive 112, or communications interface 124. The application module 106, when executed by the processors 104, causes the processors 104 to perform the functions of the invention as described herein.

Main memory 108 may be loaded with one or more application modules 106 that can be executed by processors 104 with or without a user input through I/O interface 130 to achieve desired tasks. In operation, when processors 104 execute one of the application modules 106, the results are computed and stored in the secondary memory 110 (i.e., hard disk drive 112). Results of the analysis (e.g., particle-based method) are reported to the user via the I/O interface 130 either in a text or in a graphical representation upon user's instructions.

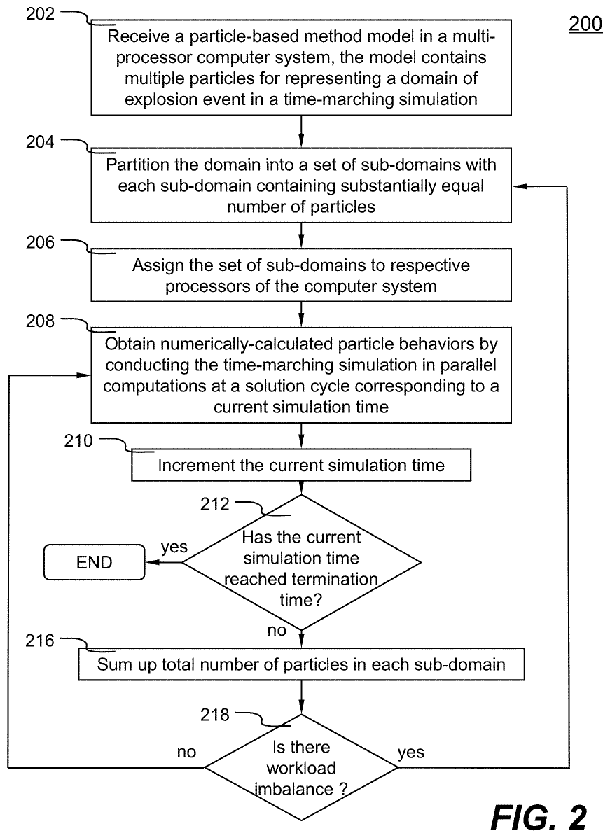

FIG. 2 is a flowchart illustrating an example process 200 of improving parallel computation efficiency in a numerical time-marching simulation of an explosion event. Process 200 is implemented in software. The numerical simulation results are used for adjusting the physical set of the explosion event.

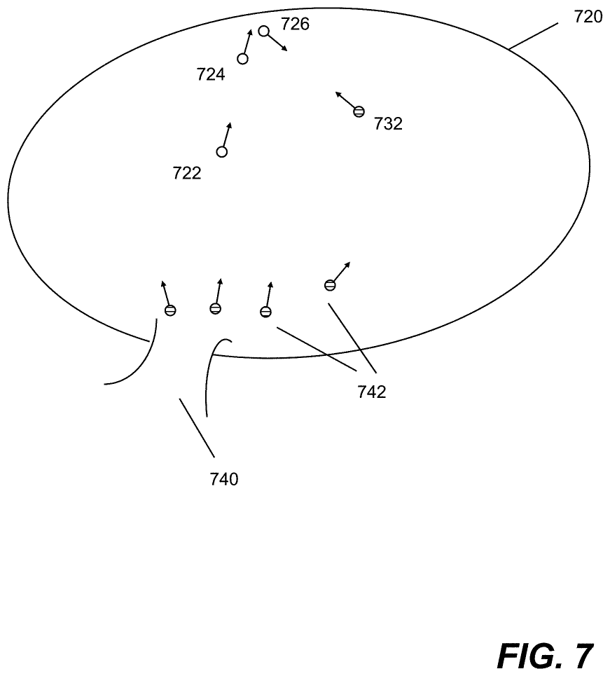

Process 200 starts at action 202 by receiving a particle-method based model in a multi-processor computer system (e.g., computer system 100). In one embodiment, particle-based method is CPM. In another embodiment, particle-based method is a customized method (e.g., a particular embodiment shown in FIG. 7 and corresponding descriptions). The particle-method based model contains a number of particles for representing a domain of an explosion event in a time-marching simulation using particle-based method.

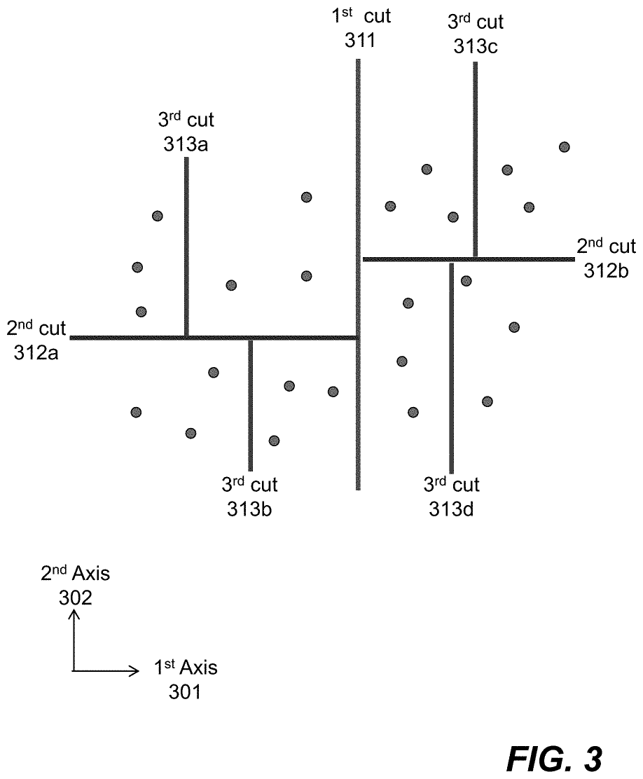

At action 204, the domain represented by the particle-method based model is partitioned or divided into a set of sub-domains with each sub-domain containing substantially equal number of particles (i.e., roughly same number of particles in each sub-domain) in accordance with a domain decomposition scheme. One example domain decomposition scheme is based on recursively coordinate bisection. FIG. 3 is a diagram showing an example two-dimension domain decomposition scheme based on recursively coordinate bisection. For illustration simplicity, two-dimension domain is used as an example to demonstrate the recursively coordinate bisection scheme. For those having ordinary skill in the art would easily extend the example scheme to partition a three-dimension domain.

The scheme divides a two-dimension domain in a number of sub-domains. It starts to divide the domain in the first axis 301 with the first cut 311, which partitions the domain to a first set of sub-domains (i.e., two sub-domains) with each sub-domain containing roughly equal number of particles. Next, the second cuts 312a-312b in the second axis 302 divide each of the first set of sub-domains into a second set of sub-domains (i.e., four sub-domains). Then the third cuts 313a-313d are done in the first axis 301 to divide the domain into eight sub-domains with substantially equal number of particles in each sub-domain.

Next, at action 206, sub-domains are assigned to respective processors of the multi-processor computer system such that each processor is used for processing the particles in the assigned sub-domain. Then, at action 208, numerically-calculated particle behaviors are obtained by conducting the time-marching simulation in parallel computations at a solution cycle corresponding to current solution time in accordance with particle-based method. The current simulation time is then incremented at action 210. For example, a time step increment is added to the current simulation time for the next solution cycle.

Process 200 moves to decision 212, the current simulation time is checked against a pre-determined termination time. If not, process 200 follows the ‘no’ branch to action 216. The total number of particles in each sub-domain is summed up. A workload indicator is created by using the total number of particles in each of the sub-domains. The workload is imbalanced, when there are significantly more number of particles in one of the sub-domain than that of another sub-domain. The criterion is set as a percentage of total number of particles. For example, 50% more in one sub-domain then another sub-domain would indicate workload imbalance. The percentage can be a tunable parameter based on the simulation type and/or computer system (e.g., number of processors). Particles and computer processors can be either homogeneous or heterogeneous. This means that more complex formula/criteria would require to calculate the workload because one type of particles may require more computational resources than other types. Some processors may be more powerful than other processors.

At decision 218, if the workload indicator shows imbalance based on a predefined criterion, process 200 follows the ‘yes’ branch to action 204 repartitioning the domain and reassign new set of sub-domains to respective processors at action 206 thereby balancing the workload for the next solution cycle of the time-marching simulation. Process 200 then repeats above-described actions and decisions started at action 208 until decision 212 becomes true.

Otherwise if decision 218 is false, no repartition of the domain is needed. Process 200 follows the ‘no’ branch to action 208 repeating the above-described actions and decisions until decision 212 becomes true. Process 200 ends thereafter.

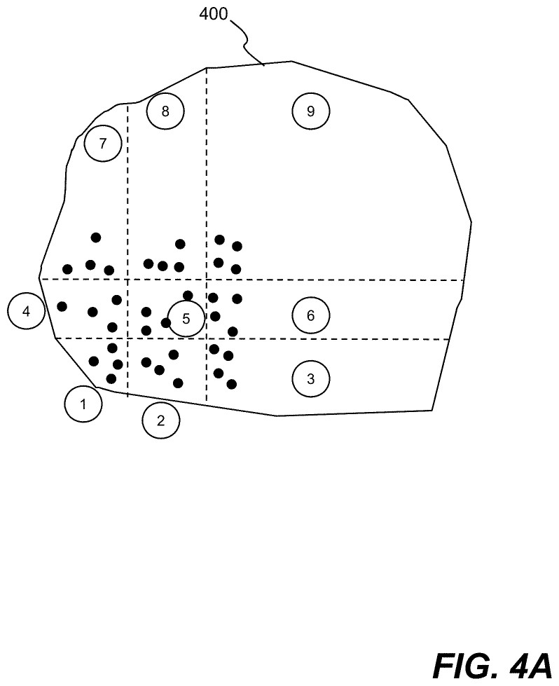

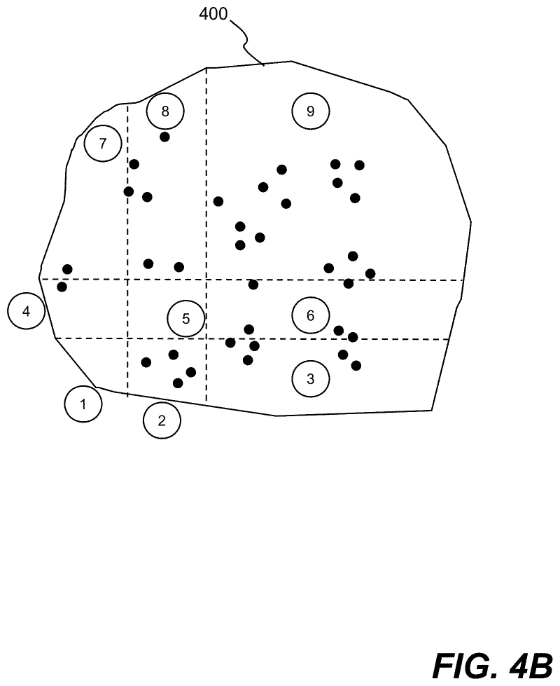

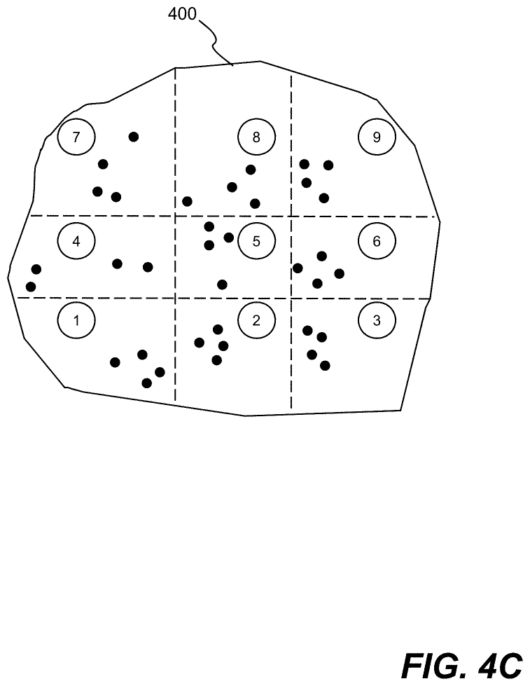

FIGS. 4A-4C are a sequence of diagrams showing example sub-domains used in particle-based method. Again for illustration simplicity, two-dimension domain 400 is partitioned into nine sub-domains. Each sub-domain is assigned to respective processors (i.e., shown as number within circle). FIG. 4A shows an initial partition with each sub-domain containing substantially equal number of particles. FIG. 4B shows a snapshot after one or more solution cycles of the time-marching simulation. The total number of particles in each of the nine sub-domains are different indicating workload imbalance in accordance with a pre-define criterion (e.g., number of homogeneous particles). In this situation, decision 218 in process 200 is true. A repartition is required. The resulting sub-domains are shown in FIG. 4C.

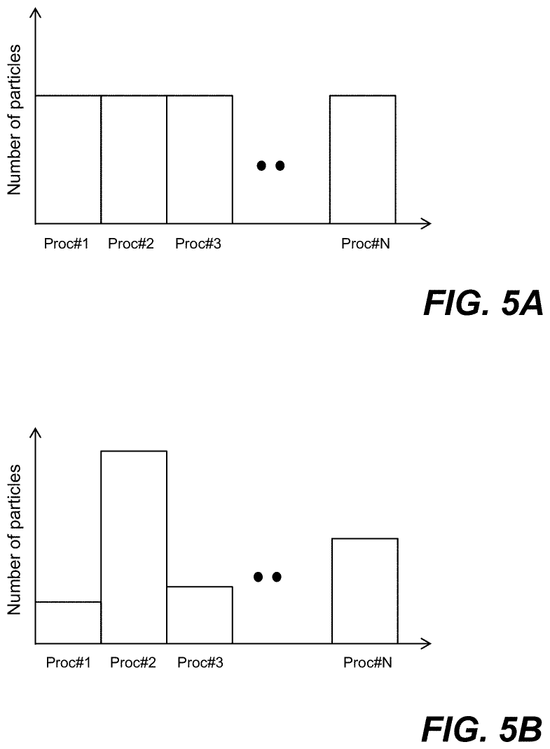

Another example to demonstrate the workload balance or imbalance is shown in FIG. 5A and FIG. 5B, respectively. The example shown in FIGS. 5A-5B is based on the assumption of numerically simulating homogeneous particles in a multiple-processor computer system with homogeneous processors. The total number of particles are equal in each of the N processors or sub-domains in FIG. 5A thereby the workload is balanced. FIG. 5B shows drastically different number of particles in respective processors or sub-domains, which indicates workload imbalance. N is a positive integer.

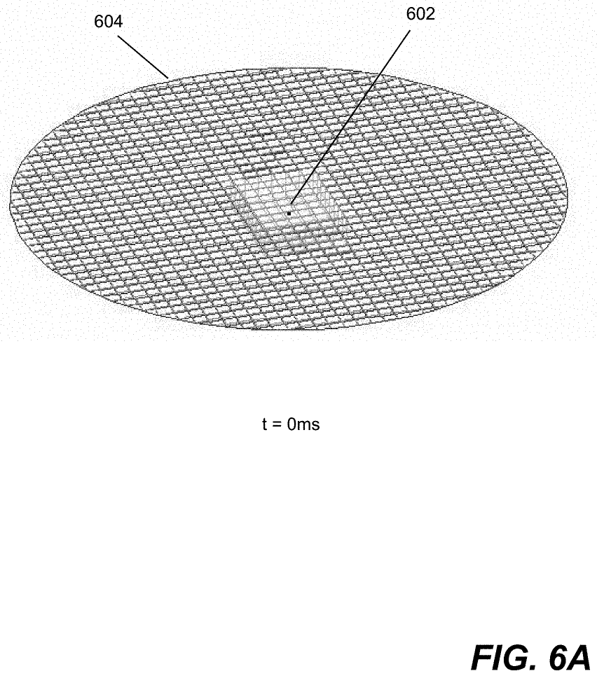

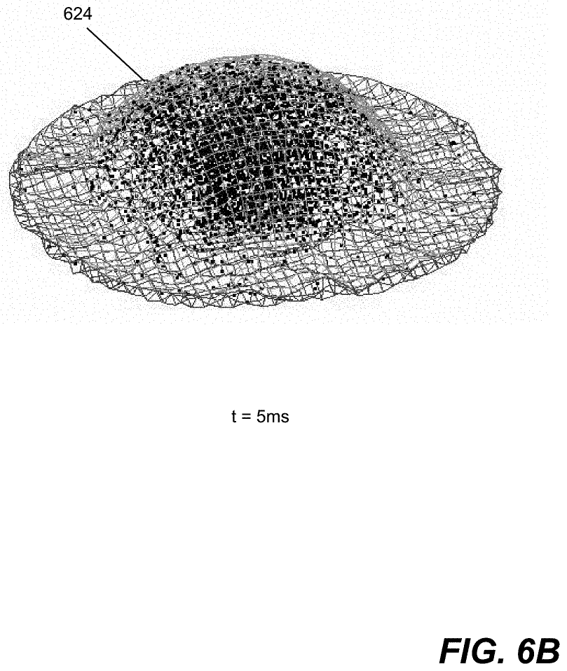

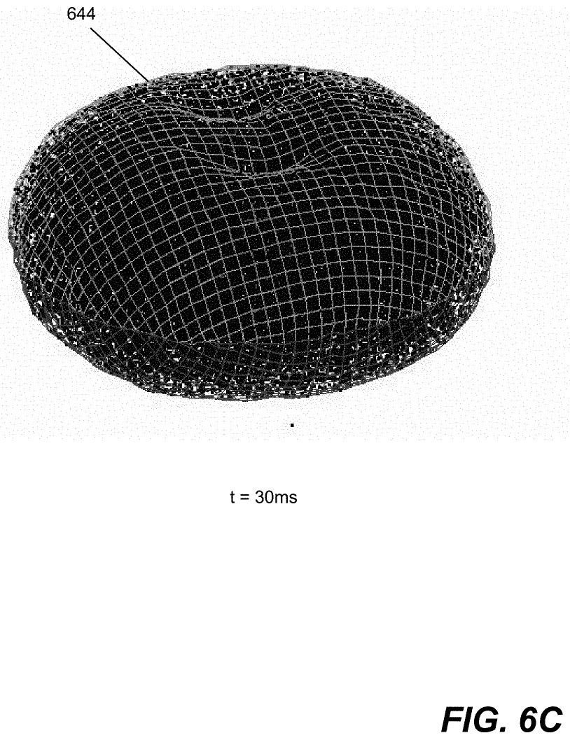

A specific example of time-marching simulation of an explosive event is shown FIGS. 6A-6C, which are a sequence of numerically-calculated particle behaviors of an airbag deployment during a car crash. Airbag has been proved to save many vehicle occupants during a car crash. However, there are incidents that the deployment of the airbag may cause injury to the vehicle occupants. Therefore, a realistic simulation of the airbag deployment in a car crash is important to a better design. Numerical simulation of inflation of the airbag (i.e., an enclosed volume with flexible boundary) using gas particles. The airbag in its initial folded configuration 604 is shown in FIG. 6A. The nozzle 602 is located in the center of the airbag. FIG. 6B shows the airbag configuration 624 at 5 ms after the initiation. It is evident that the airbag is partially inflated at this stage. Finally, FIG. 6C shows the fully inflated airbag configuration 644 at 30 ms after the initiation.

In one particular embodiment of particle-based method shown in FIG. 7, a first particle 722 may collide with a flexible boundary 720 and/or with a second particle 732. The boundary 720 represents a flexible boundary of an enclosed volume. The boundary 720 may be made of plastics, fabrics, leathers, and the likes. In one embodiment, the initial geometry and material of the flexible boundary is defined in a finite element analysis model. The geometry of the boundary is represented by a plurality of the shell elements. The material of the boundary is represented by the nodal mass and the section properties of the shell elements. A plurality of new gas particles 742 is created in the enclosed volume at each solution cycle. The new gas particles travel through a nozzle 740 in random directions. Each of the new particles possesses a pre-determined mass m and a calculated average velocity v based on the temperature. The initial momentum and the translational kinetic energy of each of the particles are then computed with the mass and the average velocity as follows:

Momentum I=mv

Translational Energy E_{TR}=½mv²

The total energy of a particle E_{TOT} has two components: translation E_{TR} and spinning-plus-vibration E_{SV}.

E_{TOT}=E_{TR}+E_{SV}

The initial balanced ratio α₀=E_{SV}/E_{TR} is fixed for a particular type of gases (e.g., ⅔ for air, 0 for helium). All of new and existing particles may collide with each other and with the boundary at each solution cycle. At each collision, an energy transfer will happen between the particle and the boundary or between the particles. The energy transfer is based the principles of mass, momentum and energy conservation as follows:

mₐ₀+M_{b0}=mₐ₁+m_{b1}

Iₐ₀+I_{b0}=Iₐ₁+I_{b1}

E_{TOT a0}+E_{TOT b0}=E_{TOT a1}+E_{TOT b1}

where the subscripts a and b represent two objects (i.e., particle and boundary, or particle and particle), and the subscripts 0 and 1 represent the state before and after the collision, respectively. In addition, the energy transfer also follows a set of rules as follows: 1) only the translation component is transferred in a particle-to-boundary collision; and 2) the initial balance ratio is restored only after a particle-to-particle collision.

Using the gas particles 722 as an example, each of the gas particles 722 is created in the enclosed volume and travels towards the boundary 720. The particle energy E_{TOT} has two components: translation E_{TR} and spinning-plus-vibration E_{SV}. Just before the particle 722 collides with the boundary 720, the particle 722 is in position 724 having E_{SV} and E_{TR} with ratio α₀. Similar, the boundary 720 has a mass and velocity. The mass of the boundary 720 at the point of collision is represented by an effective mass. In one embodiment, the effective mass is computed using nodal masses of a shell element in a finite element analysis model. The local coordinates of the shell element at the point of collision are used in the shape function of the shell element to calculate the contribution from each of the nodal masses. Right after the collision at position 726, a portion of translation component E_{TR} is transferred to the boundary 720. The gas particle 722 carries a smaller E_{TR} with a ratio α₁, which is greater than α₀ due to the reduction of E_{TR}. The particle 722 travels further and collides with another particle 732. The particles 722 and 732 exchange energies and the initial balanced ratio α₀ is restored, while the velocity and the total translational energy are different after the collision. For illustration simplicity, only one particle 722 collides with the boundary 720 and with another particle 732 are shown in FIG. 7.

Although the invention has been described with reference to specific embodiments thereof, these embodiments are merely illustrative, and not restrictive of, the invention. Various modifications or changes to the specifically disclosed example embodiments will be suggested to persons skilled in the art. For example, whereas SPH has been shown and described as the particle-based method, other particle-based methods may be used for achieving the same, for example, meshfree method, discrete element method, other customized method, etc. Additionally, whereas two-dimension domain has been shown and described to demonstrate domain decomposition scheme, three-dimension domain can be used in the invention to achieve the same. Moreover, whereas only few particles have been shown and described, the invention does not limit the number of particles in a domain and/or a sub-domain, for example, thousands or even millions of particles may be used in the invention. Furthermore, whereas each sub-domain has been described and shown to be assigned to a unique processor in a multi-processor computer system, in certain situation, more than one sub-domains may be assigned to the same processor to improve parallel computation efficiency. In summary, the scope of the invention should not be restricted to the specific example embodiments disclosed herein, and all modifications that are readily suggested to those of ordinary skill in the art should be included within the spirit and purview of this application and scope of the appended claims.

I claim:

1. A method of improving parallel computation efficiency comprising:
(a) receiving a particle-based method model in a multi-processor computer system having a particle-based method application module installed thereon, the numerical simulation model containing a plurality of particles for representing a domain of an explosion event in a time-marching simulation;
(b) partitioning, with the particle-based method application module, the domain into a plurality of sub-domains with each sub-domain containing substantially equal number of particles in accordance with a domain decomposition scheme;
(c) assigning, with the particle-based method application module, the plurality of sub-domains to respective processors of the multi-processor computer system;
(d) obtaining, with the particle-based method application module, numerically-calculated particle behaviors by conducting the time-marching simulation in parallel computations at a solution cycle corresponding to a current simulation time in accordance with the particle-based method;
(e) increment, with the particle-based method application module, the current simulation time;
(f) when the simulation time has not reached a predefined termination time,
summing up, with the particle-based method application module, total number of particles in said each sub-domain; and
repeating (b)-(c) if an indicator derived from the total number of particles in said each sub-domain shows workload imbalance;
repeating (d)-(f) until the simulation time has reached the predefined termination time.

2. The method of claim 1, wherein the particle-based method is based on Corpuscular Particle Methodology.

3. The method of claim 1, wherein the domain decomposition scheme is based on recursively coordinate bisection.

4. The method of claim 1, wherein the indicator comprises substantially larger percentage of particles in a first sub-domain of the plurality of sub-domains than that of a second sub-domain, when the particles are homogeneous.

5. The method of claim 1, wherein numerically-calculated particle behaviors are used for adjusting a physical setup of the explosion event.

6. The method of claim 5, wherein the explosion event is used for inflating an airbag in an automobile during crash.

7. A system for improving parallel computation efficiency comprising;
a memory for storing computer readable code for a particle-based method application module;
a plurality of processors coupled to the memory, said processors executing the computer readable code in the memory to cause the particle-based method application modules to perform operations of:
(a) receiving a particle-based method model, the numerical simulation model containing a plurality of particles for representing a domain of an explosion event in a time-marching simulation;
(b) partitioning the domain into a plurality of sub-domains with each sub-domain containing substantially equal number of particles in accordance with a domain decomposition scheme;
(c) assigning, the plurality of sub-domains to respective processors of the multi-processor computer system;
(d) obtaining with the particle-based method application module, numerically-calculated particle behaviors by conducting the time-marching simulation in parallel computations at a solution cycle corresponding to a current simulation time in accordance with the particle-based method;
(e) increment the current simulation time;
(f) when the simulation time has not reached a predefined termination time,
summing up total number of particles in said each sub-domain; and
repeating (b)-(c) if an indicator derived from the total number of particles in said each sub-domain shows workload imbalance;
repeating (d)-(f) until the simulation time has reached the predefined termination time.

8. The system of claim 7, wherein the particle-based method is based on Corpuscular Particle Methodology.

9. The system of claim 7, wherein the domain decomposition scheme is based on recursively coordinate bisection.

10. The system of claim 7, wherein the indicator comprises substantially larger percentage of particles in a first sub-domain of the plurality of sub-domains than that of a second sub-domain, when the particles are homogeneous.

11. The system of claim 7, wherein numerically-calculated particle behaviors are used for adjusting a physical setup of the explosion event.

12. The system of claim 11, wherein the explosion event is used for inflating an airbag in an automobile during crash.

13. A non-transitory computer readable medium containing instructions for improving parallel computation efficiency by a method comprising:
(a) receiving a particle-based method model in a multi-processor computer system having a particle-based method application module installed thereon, the numerical simulation model containing a plurality of particles for representing a domain of an explosion event in a time-marching simulation;
(b) partitioning, with the particle-based method application module, the domain into a plurality of sub-domains with each sub-domain containing substantially equal number of particles in accordance with a domain decomposition scheme;
(c) assigning, with the particle-based method application module, the plurality of sub-domains to respective processors of the multi-processor computer system;
(d) obtaining, with the particle-based method application module, numerically-calculated particle behaviors by conducting the time-marching simulation in parallel computations at a solution cycle corresponding to a current simulation time in accordance with the particle-based method;
(e) increment, with the particle-based method application module, the current simulation time;
(f) when the simulation time has not reached a predefined termination time,
summing up, with the particle-based method application module, total number of particles in said each sub-domain; and
repeating (b)-(c) if an indicator derived from the total number of particles in said each sub-domain shows workload imbalance;
repeating (d)-(f) until the simulation time has reached the predefined termination time.

14. The non-transitory computer readable medium of claim 13, wherein the particle-based method is based on Corpuscular Particle Methodology.

15. The non-transitory computer readable medium of claim 13, wherein the domain decomposition scheme is based on recursively coordinate bisection.

16. The non-transitory computer readable medium of claim 13, wherein the indicator comprises substantially larger percentage of particles in a first sub-domain of the plurality of sub-domains than that of a second sub-domain, when the particles are homogeneous.

17. The non-transitory computer readable medium of claim 13, wherein numerically-calculated particle behaviors are used for adjusting a physical setup of the explosion event.

18. The non-transitory computer readable medium of claim 17, wherein the explosion event is used for inflating an airbag in an automobile during crash.
